(19) United States
(12) Patent Application Publication
(10) Pub. No.: US 2002/0148868 A1
(43) Pub. Date: Oct. 17, 2002

(54) Attachable beverage container holder

(76) Inventors: Diane Marie Dion-Bildstein, Grapevine, TX (US); Dean Edward, Grapevine, TX (US)

Correspondence Address: Amy Natasha Slivocka, Roberts & Smaby, P.C., Suite 4050, 1717 Main Street, Dallas, TX, 75201, US

(21) Appl. No.: 10/124,112

(22) Filed: Apr. 17, 2002

Related U.S. Application Data
(60) Provisional application No. 60/284,129, filed on Apr. 17, 2001.

(51) Int. Cl. B60R 7/00; B60R 9/00

(52) U.S. Cl. 224/401; 224/409; 224/411; 224/926

(57) ABSTRACT

A holder for a beverage container device includes a top ring having a cavity through which a container can be inserted and a downwardly extending vessel adapted to the top ring in order to encircle the container. In addition, a pair of straps extends upwardly from the top ring to encircle the environmental object enabling the vessel, attached to the top ring, to swing back and forth under the influence of gravity when the environmental object shifts to a downward angle, thereby keeping the vessel in an upright position. The support straps also are adjustable in length to allow for the several different types of environmental objects known today.

### BACKGROUND OF THE INVENTION

Persons engaged in activities such as traveling, shopping, exercising, participating in sporting events, yard work or the like, enjoy beverages such as those contained within cups, glasses, and cans. In most of these activities the person's hands grip an object such as luggage, shopping carts, exercise equipment, athletic equipment, lawn equipment, etc. When both hands of such a person are entirely unavailable, however, there is no way to simultaneously carry a beverage container.

For example, it becomes very difficult to perform even the simplest of tasks when traveling, if a person attempts to carry luggage and a beverage at the same time, without any assistance. Opening doors, walking to the appropriate gate, and sometimes running to catch the person's flight cannot take place without the inevitable spill.

In response to these problems, the popularity of holders for supporting drinking glasses and cans has increased immeasurably. Consequently, beverage container holders have enjoyed considerable success in recent years.

U.S. Pat. No. 6,098,860 discloses a cup holding device including a main beverage container holding member, conformed to hold large heavy drinking cups, two support straps are connected to one side of the main cup holding member, one strap is connected at the top of the main cup holding member and the other strap is connected at the bottom of the main cup holding member, directly below the first strap allowing the device to strap to a vehicle dashboard.

U.S. Pat. No. 6.004,033 discloses a neoprene water bottle holder formed by sewing a first edge of a sheet of neoprene material to a second edge of the sheet of material to form a generally cylindrical shaped water bottle holder with a Velcro™ attachment mechanism to enable the water bottle holder to attach to and be removed from a piece of exercise equipment or other structure.

U.S. Pat. No. 5,622,346 discloses a collapsible container holder that can be used to hold containers, and can be used during walking, jogging or hiking. The container holder includes: a single vertical strap which is folded along its width to form two legs of a J-shape and has a plurality of loops along the length of the vertical strap; a plurality of horizontal straps which are inserted into the loops in the vertical strap and loop fastening means to form a round shaped pouch for holding the container, and a separate loop at the top of the vertical member to allow for external support.

U.S. Pat. No. 5,511,754 discloses a cup holding device directed to a cup holding device which can be hung from a seat back in a stadium or the like including a ring having an opening through which a cup can be inserted; two straps secured to the ring; a hook member secured to the free end of each strap for hanging the cup supporting device from a chair back; a helical coil spring; and a stop bar secured in diametrical relation across the lower end of the helical coil spring for supporting the cup within the helical coil spring.

U.S. Pat. No. 6,328,146 discloses a piece of baggage with a retractable pocket that is configured to support a beverage container on the exterior of the piece of baggage. The pocket is constructed of a mesh material and has an elastic strap along an upper edge that allows the pocket to expand to support various size containers.

However, many people's experiences with these “cup holders” have not been pleasant. The typical beverage container holders are constructed of plastic, cardboard or other non-flexible material. This is undesirable for several reasons, including cost, the need to mechanically secure the holder, the difficulty in moving the beverage container, and most importantly, spills occur when the object to which the typical beverage container holder is attached moves to any position other than a 90-degree angle. Additionally, the typical beverage container holders are not generally designed to hold anything except a soft drink can.

Further, the flexible container holders made of nylon or the like, have their own disadvantages. Flexible beverage container holders are often difficult to attach to environmental objects and are also flimsy, thereby failing to stay upright, which in turn produces a spill.

In order to provide a convenient means to intermittently drink from a beverage container without interrupting the user's activities, we have designed and successfully constructed an attachable beverage container holding device. The structural characteristics of the device allow for a unique pendulum action so that drinks are handy and upright. The Universal-size beverage container holder handles cups, cans, bottles, and insulated drink holders.

### BRIEF SUMMARY OF THE INVENTION

The invention herein disclosed overcomes the disadvantages of prior art drink holders by providing a unique flexible beverage container holder that can be easily attached and removed from environmental objects. The vessel of the present invention is specifically configured for holding a beverage container. However, unlike prior art beverage containers, the present invention allows for a flexible and collapsible beverage container holder that keeps drinks upright during travel or motion by utilizing a balancing pendulum effect.

In general, the beverage container holder of the present invention comprises a vessel that is suspended, in an upright position. by two straps from an environmental object, such that when the environmental object shifts to a downward angle, the vessel swings back and forth under the influence of gravity, keeping the vessel in an upright position.

Additionally, in the preferred embodiment, straps extend upwardly on both sides of the top ring of a mesh cone-shaped vessel and are intended to loop around a portion of the environmental object by means of attachment mechanisms on both ends of said straps. This allows the beverage container holder to be easily attached and removed from the environmental object. In an alternate embodiment, the vessel has a floor. Regardless of the particular embodiment, the use of the invention is not limited to any particular type of luggage and various types of environment objects such as, shopping carts, exercise equipment, athletic equipment, lawn equipment, can benefit therefrom.

The foregoing outlined some of the more pertinent features of the present invention. One should construe these features as merely illustrative of some of the more prominent features and applications of the invention. One may obtain many other beneficial results when applying the disclosed invention in a different manner or modifying the invention as described. Accordingly, one may recognize other features and a fuller understanding of the invention when referring to the following Detailed Description of the Preferred Embodiment.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the Detailed Description of the Invention, serve to explain the principles of the present invention.

FIG. 1 is a perspective view of a container holding device according to the present invention shown in an expanded view for supporting a container.

FIG. 2 is a perspective view of an alternate embodiment of the present invention shown with a bottom floor for supporting a container.

FIG. 3 is a perspective view of a container holding device according to the present invention shown attached to an environmental object.

FIG. 4 is a perspective view of a container holding device according to the present invention shown attached to luggage.

### DETAILED DESCRIPTION OF THE INVENTION

Preferred embodiments of the present invention are illustrated in the FIGURES, like numerals being used to refer to like and corresponding parts of the various drawings. The particular values and configurations discussed in these non-limiting examples, however, can be varied and are cited merely to illustrate an embodiment of the present invention and are not intended to limit the scope of the invention.

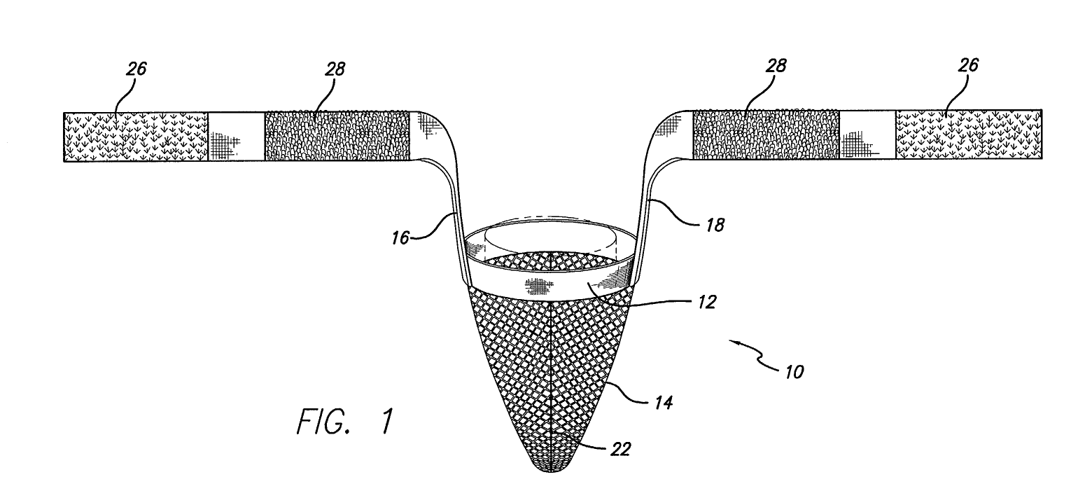

A shown best in FIGS. 1, 3 and 4, the beverage container holder 10 is constructed from lightweight and flexible fabric materials to better expand to hold various sizes of containers and to enable the user to store the beverage container holder. The beverage container holder 10 is provided with a top ring 12, composed of a lateral strip forming a loop around the cavity through which a container can be inserted, a vessel 14 which is sewn or otherwise fastened to the bottom portion of the top ring 12, preferably by reinforced stitching, for receiving and supporting a container and a first strap 16 and a second strap 18 securely fastened to a top ring 12 for attachment to an environmental object 20.

More particularly, the vessel 14 comprises a generally conical body that may be constructed as shown from a lightweight mesh fabric, sewn at the upper edge to the lower edge of the top ring 12. The mesh vessel 14 of this embodiment is preferably made from two pieces of mesh material having two equal length and widths. The side edges of the mesh portion are preferably slightly narrower toward the base so that when the edges of the mesh portion are sewn together 22 the mesh material forms a conical vessel 14.

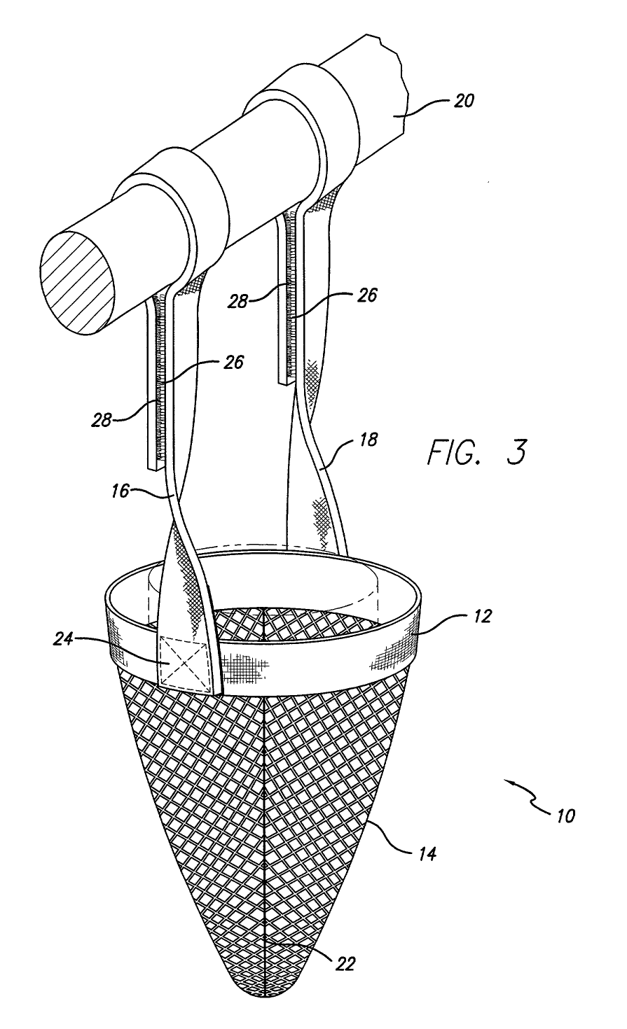

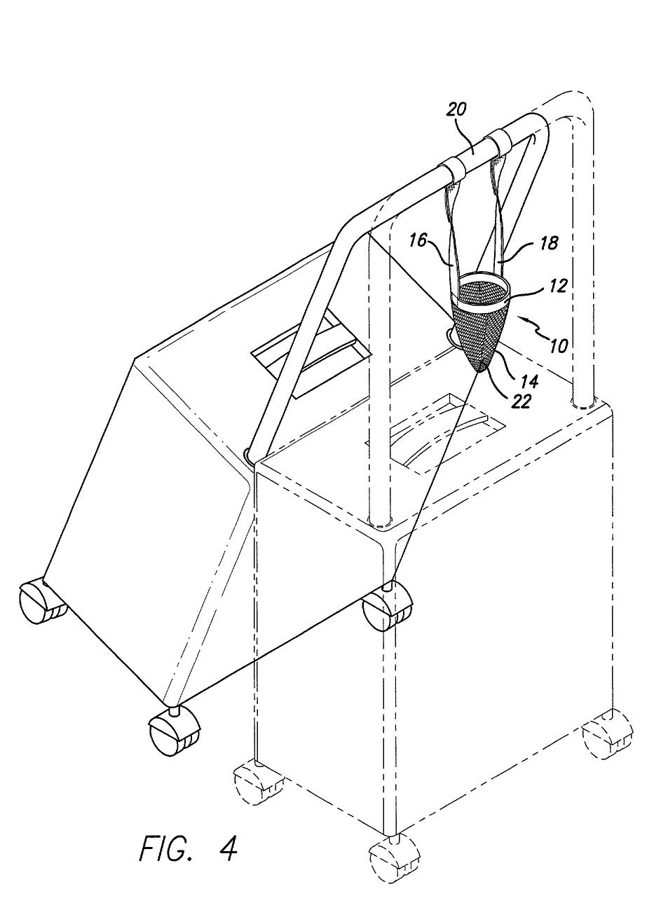

As best shown in FIGS. 3 and 4 the beverage container holder of the present invention utilizes both a first strap 16 and second strap 18 extending upward on both sides of the top ring 12 and which are looped around and fastened to an environmental object 20. The preferred means by which the straps attach to the top ring 12 is sewing with reinforced stitching 24. The straps are fastened to themselves by an attachment means. Although snaps, hooks, clips, and latches may be used as attachment mechanisms, a loop and pile connector set, that is, the two-part hook 26 and loop 28 fabric material referred to under the tradename Velcro™, is the preferred means of attachment. This allows the beverage container holder to be easily attached and removed from the environmental object 20 by merely separating the ends of the straps. The Velcro™ fastening device is adjustable to fasten around any number of different size structural components on luggage, shopping carts, exercise equipment, athletic equipment lawn equipment, or the like.

The entire attachable beverage container holder is preferably made of non-metallic, flexible material, such as nylon.

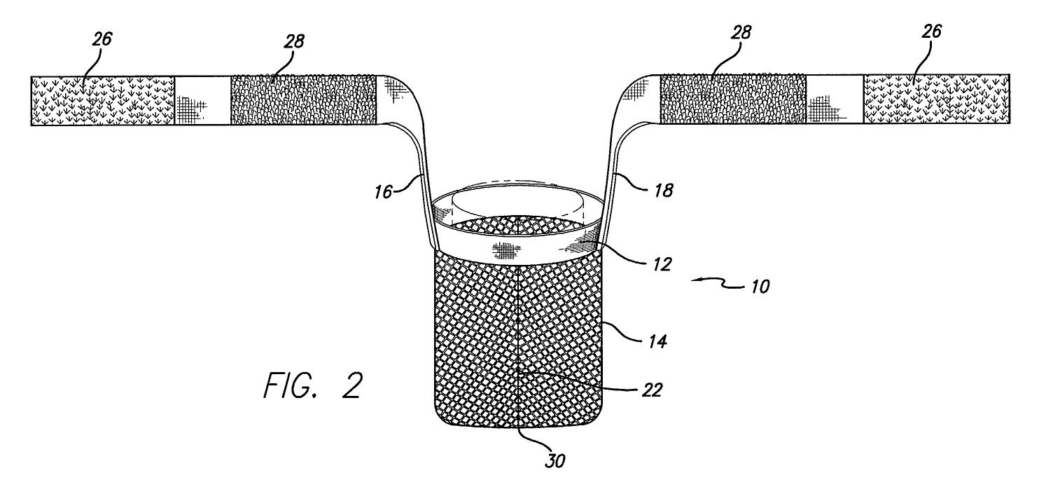

The alternate embodiment shown and described in FIG. 2 the vessel 14 comprises is a generally cylindrical body that may be constructed as shown from a lightweight mesh fabric, sewn at the upper edge to the lower edge of the top ring 12. The mesh vessel 14 of this alternate embodiment is preferably made from three pieces of mesh material two of which has equal lengths and widths, the third circular piece. When the edges of the two matching pieces of mesh are sewn together 20 and the third circular piece of mess 30 is sewn to the base of the combined matching pieces the mesh material forms a cylindrical vessel 14.

FIG. 4 illustrates how the beverage container holder 10 is securely fastened to an environmental object 20, such as luggage, such that when the environmental object 20 shifts to a downward angle the vessel swings back and forth under the influence of gravity, keeping the vessel in an upright position.

The embodiments and examples set forth herein are presented to best explain the present invention and its practical application and to thereby enable those skilled in the art to make and utilize the invention. Those skilled in the art, however, will recognize that the forgoing description and examples have been presented for the purpose of illustration and example only. Other variations and modifications of the present invention will be apparent to those of skill in the art. The description as set forth is not intended to be exhaustive to limit the scope of the invention. It is contemplated that the use of the present invention can involve components having different characteristics.

What is claimed is:

1. A beverage container holder for securement onto an environmental object, comprising:
a top ring having an opening through which a container can be inserted;
a vessel for holding the container therein and for restraining sideward movement of said container wherein the crown of the vessel connects to the top ring;
two straps securely fastened to the top ring at each of said straps first ends;
attachment means at the second ends of each of said straps for removably securing said straps to the external support by encircling same.

2. The beverage container holder of claim 1 wherein said vessel is formed from a fabric material collapsible to a generally planar state for compact storage and for unfurling to an upwardly open, generally cylindrical shape in the deployed position.

3. The beverage container holder of claim 1 wherein said straps are formed from a flexible fabric material.

4. The beverage container holder of claim 1 wherein the first ends of the straps are securely fastened to the top ring by stitching with a thread having a nylon-polyester blend.

5. The beverage container holder of claim 1 wherein the two straps diametrically oppose each other with respect to the top ring.

6. A beverage container holder for securement onto an environmental object, comprising:
a top ring having an opening through which a container can be inserted;
a vessel for holding the container therein and for restraining sideward movement of said container wherein the crown of the vessel connects to the top ring;
two straps securely fastened to the top ring at each of said straps first ends;
a hook and loop fastening strip and the second ends of said straps allowing for a variable loop size to fasten the second ends of said straps to an environmental object.

7. The beverage container holder of claim 6 wherein the hook and loop fastening strips are made of polypropelene.

8. The beverage container holder of claim 6 wherein said straps are formed from a flexible fabric material.

9. The beverage container holder of claim 6 wherein the first ends of the straps are securely fastened to the top ring by stitching with a thread having a nylon-polyester blend.

10. A beverage container holder for securement onto an environmental object, comprising:
a vessel for holding the container having a top ring, a bottom wall, and side sections therebetween, said top ring defining an opening therethrough in which containers are insertable;
a first longitudinal strip, wherein an end of said first longitudinal strip connects to the top ring;
a second longitudinal strip, wherein an end of said second longitudinal strip connects to the top ring and wherein said second longitudinal strip diametrically opposes the first longitudinal strip;
a first attachment means connectively secured to the first longitudinal strip allowing for a variable loop size to fasten the first longitudinal strip to the environmental object; and
a second attachment means connectively secured to the second longitudinal strip allowing for a variable loop size to fasten the second longitudinal strip to the environmental object.

11. The beverage container holder of claim 10 wherein said straps are formed from a flexible fabric material.

12. The beverage container holder of claim 10 wherein the first ends of the straps are securely fastened to the top ring by stitching with a thread having a nylon-polyester blend.
